(19) United States
(12) Patent Application Publication
(10) Pub. No.: US 2026/0234013 A1
(43) Pub. Date: Aug. 13, 2026

(54) PLANT AND PROCESS FOR PRODUCING A SOLID-STATE ALKALI METAL CYANIDE PRODUCT CONTAINING ALKALI METAL HYDROXIDE

(71) Applicant: CyPlus GmbH, Darmstadt (DE)

(72) Inventors: Markus Jafeld, Frechen (DE); Ralf Struffert, Koeln (DE)

(73) Assignee: CyPlus GmbH, Darmstadt (DE)

(21) Appl. No.: 18/872,997

(22) PCT Filed: Jun. 6, 2023
(86) PCT No.: PCT/EP2023/065087

§ 371 Date: Dec. 9, 2024

(30) Foreign Application Priority Data
Jun. 10, 2022 (DE) 10 2022 002 086.6

(51) Int. Cl. C01C 3/10; C01D 1/04

(52) U.S. Cl. CPC C01C 3/10; C01D 1/04

(57) ABSTRACT

The present invention relates to a plant and to a process for producing a solid-state alkali metal cyanide product. In order to obtain a solid-state alkali metal cyanide product that has a good proportion by weight of alkali metal hydroxide, and in order to ensure that it remains as calm as possible in the plant during operation, it is proposed that the proportion by weight of alkali metal hydroxide in a suspension withdrawn from the crystallization vessel and sent to a solid-liquid separation device be increased before it enters the solid-liquid separation device.

The present invention relates to a plant and to a process for producing a solid-state alkali metal cyanide product containing alkali metal hydroxide.

The term “solid-state product” in the present case means that at least 50% by weight of the solid-state product is in solid form. The solid-state product, apart from a solid phase, may also contain a liquid phase.

If alkali metal cyanide comes into contact with an acid, breakdown of alkali metal cyanide takes place, in which hydrogen cyanide is released. Even contact with slightly carbonated water, which can form, for example, when carbon dioxide from the ambient air dissolves in water, is sufficient. In order to counteract unwanted release of hydrogen cyanide in the course of storage, handling and use of alkali metal cyanide, alkali metal cyanide products contain some alkali metal hydroxide. The alkali metal hydroxide neutralizes the acid, for example carbonated water, and hence prevents the breakdown of alkali metal cyanide. On the other hand, too high a proportion of alkali metal hydroxide is problematic owing to its hygroscopic action, especially for rather dry solid-state alkali metal cyanide products, which can form lumps as a result of water absorbed from the air.

For producing solid-state alkali metal cyanide products containing alkali metal hydroxide, plants with a crystallization vessel can be used in which aqueously dissolved alkali metal hydroxide that has been consumed in the formation of aqueously dissolved alkali metal cyanide is replaced. These plants can be subject to disturbed behavior with clearly audible hammering and pounding.

Such a plant is known from GB 858,844 A. The plant has an evaporative crystallizer having a crystallization vessel under subatmospheric pressure with a suspension collection space. Present in the suspension collection space is a first suspension which contains a liquid phase with aqueously dissolved sodium cyanide and aqueously dissolved sodium hydroxide, and a solid phase with sodium cyanide crystals. First suspension is led out of the suspension collection space through a suspension withdrawal conduit and into a rotation filter, with which sodium cyanide crystals are filtered out of the first suspension. In this context, the first suspension is separated into a solid-state sodium cyanide product and a second suspension having a lower proportion by weight of sodium cyanide crystals than the first suspension. The second suspension is led into the suspension collection space of the crystallization vessel.

Upstream of the rotation filter, in a reaction loop that branches off from the suspension withdrawal conduit, a reactant gas which is essentially pure gaseous hydrogen cyanide is added to the first suspension. A reaction mixture is formed comprising a third suspension having a higher proportion of aqueously dissolved sodium cyanide and a lower proportion of aqueously dissolved sodium hydroxide compared to the first suspension. The reaction mixture is led into the suspension collection space of the crystallization vessel.

Vapors ascend from the suspension collection space. If the reaction mixture contains a gas phase, this separates off and adds to the vapors.

The vapors pass through a gas scrub. In an upper section of the crystallization vessel is provided a sieve tray which is charged with an aqueous sodium hydroxide solution and from which sodium hydroxide solution rains down. This rain is met by the vapors ascending toward the sieve tray. The vapors must also flow through the sieve tray. If the vapors contain hydrogen cyanide, contact with the sodium hydroxide solution forms further aqueously dissolved sodium cyanide. The remaining sodium hydroxide from the rain is used to replace sodium hydroxide converted in the reaction loop. GB 858,844 A states that a sodium hydroxide concentration of the mother liquor present in the suspension collection space of more than about 4% led firstly to serious bumping and pounding, and to significant vibration in the circulation system, and secondly to an undesirable product having too high a sodium hydroxide content. Therefore, it is suggested that the sodium hydroxide concentration of the mother liquor present in the suspension collection space be kept within a range from 0.2% to 3%, preferably below 1%.

DE 1064934 A states that the reaction with hydrogen cyanide can set in very vigorously when strong alkali metal hydroxide solution is used. On entry of the hydrogen cyanide into the alkali metal hydroxide solution, knocking could occur as a result of heating of the reaction mixture via heat of reaction released. In order to solve this problem, it is suggested that an alkali metal hydroxide solution already containing alkali metal cyanide be used, and the liquid present in the reaction vessel be set in such significant rotation that a distinct vortex is formed.

Even a suspension having a comparatively low alkali metal hydroxide concentration can be used to produce a comparatively dry solid-state alkali metal cyanide product with a comparatively high alkali metal hydroxide concentration. For this purpose, however, the solid-liquid separation must leave a correspondingly greater residual moisture content in the solid-state product-which still has to be dried further. However, a relatively high residual moisture content has some drawbacks. For instance, more energy is required for further drying than if separation had been effected with a lower residual moisture content. The more intensive the drying process, the greater the degree to which breakdown of alkali metal cyanide is promoted with formation of unwanted alkali metal formate and ammonia.

A higher residual moisture content is additionally associated with a higher tendency to caking. In a production plant, caked material and caking onto plant components can lead to problems, especially to blockages and to poorer heat transfer at heating and cooling surfaces.

U.S. Pat. No. 4,847,062 A discloses, in FIG. 3 thereof, a plant and a process for producing a solid-state sodium cyanide product. The plant has a vessel in which absorption and crystallization take place, and in which a first suspension is produced. The first suspension contains a liquid phase with aqueously dissolved sodium cyanide and aqueously dissolved sodium hydroxide, and a solid phase with sodium cyanide crystals. First suspension is withdrawn from the vessel through a suspension withdrawal conduit. A portion thereof is led into a recycle loop. The remainder is led into a solid-liquid separation unit in which the first suspension introduced is separated into a solid-state sodium cyanide product and a second suspension. The second suspension has a lower proportion by weight of sodium cyanide crystals than the first suspension. The second suspension is led into the recycle loop and mixed with the first suspension, which forms a third suspension. A sodium hydroxide solution is mixed into the third suspension, which forms a fourth suspension. The fourth suspension is introduced into the vessel at the top. A hydrogen cyanide-containing synthesis gas is introduced into the vessel at the bottom.

DE 1235873 A describes a plant for production of a solid-state alkali metal cyanide, having a receiver with a first suspension. The first suspension has a liquid phase with aqueously dissolved alkali metal cyanide and aqueously dissolved alkali metal hydroxide, and a solid phase with alkali metal cyanide crystals. First suspension is withdrawn from the receiver and led into a filter system in which alkali metal cyanide crystals are separated off. This forms a second suspension with a lower proportion by weight of alkali metal cyanide crystals compared to the first suspension. An alkali metal hydroxide solution is added to the second suspension, which forms a third suspension. The third suspension is led into an absorption tube, and runs down along the inner wall thereof. At the same time, a hydrogen cyanide-containing gas mixture is introduced into the absorption tube. At the bottom end of the absorption tube, there is a fourth suspension and a reaction gas mixture, which flow into the receiver. The reaction gas mixture fills an upper region of the receiver and flows out of it through a conduit.

U.S. Pat. No. 3,079,239 A discloses a plant and a process for batchwise production of an aqueous sodium cyanide solution. The plant has a reaction vessel in which a first sodium cyanide solution containing aqueously dissolved sodium cyanide and aqueously dissolved sodium hydroxide is produced. An aqueous sodium hydroxide solution and liquid hydrogen cyanide are introduced into this vessel. The supply of liquid hydrogen cyanide is controlled depending on the proportion by weight of sodium hydroxide in the first sodium cyanide solution. In order to determine the proportion by weight of sodium hydroxide of the first sodium cyanide solution, first sodium cyanide solution from the reaction vessel is led into a measurement loop, where pure water is admixed therewith for dilution, forming a second sodium cyanide solution. The second sodium cyanide solution is led into a measurement unit that measures the electrical conductivity of the second sodium cyanide solution. This is used to conclude the proportion by weight of sodium hydroxide of the first sodium cyanide solution. The second sodium cyanide solution is introduced into the reaction vessel.

It is the object of the present invention to specify a plant which has a crystallization vessel and with which a solid-state alkali metal cyanide product having a good proportion by weight of alkali metal hydroxide can be produced as calmly as possible within the plant.

The object is achieved in accordance with the invention by a plant having the features of claim 1. In the plant of the invention, the alkali admixing unit is connected downstream of the crystallization vessel and upstream of the solid-liquid separation unit. The alkali admixing unit can be used to mix the reactant liquid containing aqueously dissolved alkali metal hydroxide into the first suspension. As a result, it is possible to supply the solid-liquid separation unit with a suspension (second suspension) in which the liquid phase has a higher proportion by weight of alkali metal hydroxide than the liquid phase of the suspension (first suspension) present in the suspension collection space of the crystallization vessel. In this way, it is possible to obtain a solid-state alkali metal cyanide product which, for the purpose of higher security against unwanted release of hydrogen cyanide, has a higher proportion by weight of alkali metal hydroxide than a solid-state alkali metal cyanide product that would otherwise be obtained by solid-liquid separation of the suspension (first suspension) present in the suspension collection space of the crystallization vessel. At the same time, the proportion by weight of alkali metal hydroxide of the liquid phase of the suspension (first suspension) present in the suspension collection space of the crystallization vessel can be chosen at a lower level for the purpose of calmer plant operation than would be possible if the suspension (first suspension) present in the suspension collection space of the crystallization vessel already had to have the entire alkali metal hydroxide content required for the desired solid-state alkali metal cyanide product with higher security against unwanted release of hydrogen cyanide.

Preferably, water in the liquid phase of the first suspension can be evaporated in the crystallization vessel. This promotes the formation and growth of alkali metal cyanide crystals.

Advantageously, the second separation unit removal conduit can fluidically interconnect the solid-liquid separation unit and the crystallization vessel of the suspension production unit, and third suspension can be removed from the solid-liquid separation unit and led into the crystallization vessel through the second separation unit removal conduit. In this way, third suspension can be utilized for producing further solid-state alkali metal cyanide product. In this context, the third suspension can also be used to replace alkali metal hydroxide in the crystallization vessel that has been consumed in the formation of alkali metal cyanide. In this case, less alkali metal hydroxide gets into the crystallization vessel with the third suspension than if the reactant liquid containing aqueously dissolved alkali metal hydroxide-rather than being added to the first suspension in the alkali admixing unit-were to be introduced directly into the crystallization vessel. This is because the liquid phase of the second suspension has a higher proportion by weight of alkali metal hydroxide than the liquid phase of the first suspension, and so more alkali metal hydroxide gets into the solid-state alkali metal cyanide product. This extra alkali metal hydroxide consequently cannot any longer get into the crystallization vessel.

Favorably, the second separation unit removal conduit can have a pressure drop limiting unit through which third suspension can flow and with which an operating pressure difference between the solid-liquid separation unit and the crystallization vessel of the suspension production unit can be maintained while third suspension is flowing through the pressure drop limiting unit. In this way, third suspension can flow out of the solid-liquid separation unit into the crystallization vessel in a pressure-neutral manner in respect of the operating pressure in the crystallization vessel.

Advantageously, a reaction loop for producing a fourth suspension, containing a liquid phase with aqueously dissolved alkali metal cyanide and aqueously dissolved alkali metal hydroxide, and a solid phase with alkali metal cyanide crystals, may be provided, wherein
first suspension can be introduced into the reaction loop,
the reaction loop has a hydrogen cyanide admixing unit with which, by mixing a liquid hydrogen cyanide-containing reactant liquid into the first suspension, the fourth suspension having a lower proportion by weight of aqueously dissolved alkali metal hydroxide and a higher proportion by weight of alkali metal cyanide by comparison with the first suspension can be produced, and
fourth suspension can be introduced into the crystallization vessel.

As a result, it is possible to form alkali metal cyanide outside the crystallization vessel, which additionally contributes to calm processes.

It may preferably be the case that
the reaction loop is fluidically connected to the suspension withdrawal conduit, wherein first suspension can be removed from the suspension withdrawal conduit and led into the reaction loop, and
the reaction loop is fluidically connected to the crystallization vessel, and fourth suspension can be led from the reaction loop into the crystallization vessel.

In this way, the reaction loop can be fed from the suspension withdrawal conduit, and the suspension collection space need only be provided with one outlet for removal of first suspension rather than with two.

More preferably, an alkali feed conduit may be provided, which is fluidically connected to the crystallization vessel and through which a reactant liquid containing aqueously dissolved alkali metal hydroxide can be led into the crystallization vessel. In this way, there is a further available means of introducing aqueously dissolved alkali metal hydroxide into the crystallization vessel, especially in order to replace alkali metal hydroxide consumed in the formation of alkali metal cyanide. Moreover, in this way, it is possible to choose a smaller amount of alkali metal hydroxide which is added to the first suspension with the alkali admixing unit.

Particularly advantageously, the alkali admixing unit may be fluidically connected to the alkali feed conduit, and reactant liquid containing aqueously dissolved alkali metal hydroxide may be led from the alkali feed conduit into the alkali admixing unit. In this way, it is possible for both the alkali admixing unit and the crystallization vessel to be fed from one source with reactive liquid containing aqueously dissolved alkali metal hydroxide.

It is also the object of the present invention to specify a process by which a solid-state alkali metal cyanide product having a good proportion by weight of alkali metal hydroxide can be produced as calmly as possible within the plant used here.

This object is achieved in accordance with the invention by a process having the features of claim 9. Because the first suspension is mixed with the reactant liquid containing aqueously dissolved alkali metal hydroxide, it is possible to supply the solid-liquid separation unit with a suspension (second suspension) in which the liquid phase has a higher proportion by weight of alkali metal hydroxide than the liquid phase of the suspension (first suspension) present in the suspension collection space of the crystallization vessel. In this way, it is possible to obtain a solid-state alkali metal cyanide product which, for the purpose of higher security against unwanted release of hydrogen cyanide, has a higher proportion by weight of alkali metal hydroxide than a solid-state alkali metal cyanide product that would otherwise be obtained by solid-liquid separation of the suspension (first suspension) present in the suspension collection space of the crystallization vessel. At the same time, the proportion by weight of alkali metal hydroxide of the liquid phase of the suspension (first suspension) present in the suspension collection space of the crystallization vessel can be chosen at a lower level for the purpose of calmer plant operation than would be possible if the suspension (first suspension) present in the suspension collection space of the crystallization vessel already had to have the entire alkali metal hydroxide content required for the desired solid-state alkali metal cyanide product with higher security against unwanted release of hydrogen cyanide.

Preferably, third suspension from the solid-liquid separation unit can be led into the crystallization vessel of the suspension production unit. As a result, third suspension can be utilized for producing further solid-state alkali metal cyanide product. In this context, the third suspension can also be used to replace alkali metal hydroxide in the crystallization vessel that has been consumed in the formation of aqueously dissolved alkali metal cyanide. In this case, less alkali metal hydroxide gets into the crystallization vessel with the third suspension than if the reactant liquid containing aqueously dissolved alkali metal hydroxide-rather than being added to the first suspension in the alkali admixing unit-were to be introduced directly into the crystallization vessel. This is because the liquid phase of the second suspension has a higher proportion by weight of alkali metal hydroxide than the liquid phase of the first suspension, and so more alkali metal hydroxide gets into the solid-state alkali metal cyanide product. This extra alkali metal hydroxide consequently cannot any longer get into the crystallization vessel.

Advantageously, an operating pressure difference between the solid-liquid separation unit and the crystallization vessel can be maintained while third suspension is being led from the solid-liquid separation unit into the crystallization vessel. In this way, third suspension, for the operating pressure in the crystallization vessel, can flow into the crystallization vessel from the solid-liquid separation unit in a pressure-neutral manner.

It may more preferably be the case that
first suspension is led into a reaction loop,
in the reaction loop, a fourth suspension is produced by mixing a liquid hydrogen cyanide-containing reactant liquid into the first suspension and contains a liquid phase with aqueously dissolved alkali metal cyanide and aqueously dissolved alkali metal hydroxide, and a solid phase with alkali metal cyanide crystals, wherein the fourth suspension has a lower proportion by weight of aqueously dissolved alkali metal hydroxide and a higher proportion by weight of alkali metal cyanide compared to the first suspension, and
the fourth suspension is led into the crystallization vessel.

It is possible thereby to form aqueously dissolved alkali metal cyanide outside the crystallization vessel, which additionally contributes to calm processes.

Preferably, a reactant liquid containing aqueously dissolved alkali metal hydroxide can be led into the crystallization vessel through an alkali feed conduit. There is thus a further available means of introducing aqueously dissolved alkali metal hydroxide into the crystallization vessel, especially in order to replace alkali metal hydroxide consumed in the formation of alkali metal cyanide.

Moreover, in this way, it is possible to choose a smaller amount of alkali metal hydroxide which is added to the first suspension to form the second suspension.

Particularly favorably, reactant liquid containing aqueously dissolved alkali metal hydroxide may be removed from the alkali feed conduit and, in step (c), mixed into the first suspension.

In this way, both the reactant liquid used in step (c) and the reactant liquid which is led (directly) into the crystallization vessel can be fed in from one source.

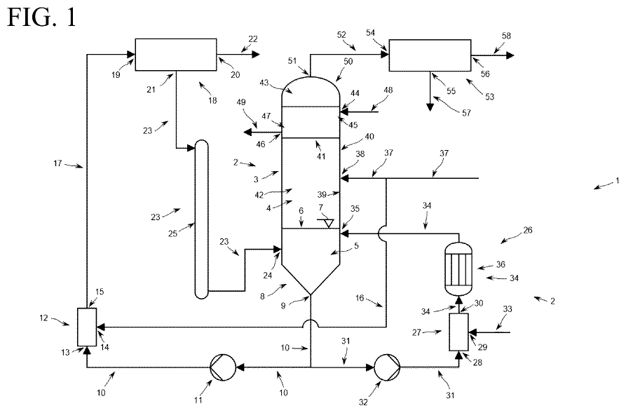

FIG. 1 shows an embodiment of the invention by means of a schematic flow diagram, which is described below.

FIG. 1 illustrates, by a schematic flow diagram, a plant 1 for producing a solid-state alkali metal cyanide product containing alkali metal hydroxide. The plant 1 has a suspension production unit 2 with a crystallization vessel 3, in the interior 4 of which is provided a suspension collection space 5 for collecting suspension. Present in the suspension collection space 5 is a first suspension which contains a liquid phase with aqueously dissolved alkali metal hydroxide and aqueously dissolved alkali metal cyanide, and a solid phase with alkali metal cyanide crystals. The first suspension has a surface 6 also indicated by a surface symbol 7 in FIG. 1.

In the region of a lower end 8 of the crystallization vessel 3, the crystallization vessel 3 has a first outlet 9 to which a suspension withdrawal conduit 10 is fluidically connected. First suspension can be removed from the suspension collection space 5 through the suspension withdrawal conduit 10. The suspension withdrawal conduit 10 has a first pump 11.

The plant 1 has an alkali admixing unit 12 with which a reactant liquid containing aqueously dissolved alkali metal hydroxide can be mixed into the first suspension for producing a second suspension containing a liquid phase with aqueously dissolved alkali metal cyanide and aqueously dissolved alkali metal hydroxide, and a solid phase with alkali metal cyanide crystals, wherein the proportion by weight of alkali metal hydroxide of said reactant liquid is higher than the proportion by weight of alkali metal hydroxide in the liquid phase of the first suspension.

The alkali admixing unit 12 has a first inlet 13, a second inlet 14 and an outlet 15. The suspension withdrawal conduit 10 is fluidically connected to the first inlet 13. The suspension withdrawal conduit 10 thus fluidically interconnects the suspension collection space 5 of the crystallization vessel 3 and the alkali admixing unit 12.

First suspension can be led from the suspension collection space 5 into the alkali admixing unit 12 through the suspension withdrawal conduit 10.

A first alkali feed conduit 16 is fluidically connected to the second inlet 14. The reactant liquid containing aqueously dissolved alkali metal hydroxide can be led into the alkali admixing unit 12 through the first alkali feed conduit 16.

An alkali admixing unit removal conduit 17 is fluidically connected to the outlet 15. Second suspension can be removed from the alkali admixing unit 12 through the alkali admixing unit removal conduit 17.

The plant 1 has a solid-liquid separation unit 18 with which, in the course of separating off solid phase of the second suspension, the second suspension can be separated into a solid-state alkali metal cyanide product and a third suspension, wherein the third suspension contains a liquid phase with aqueously dissolved alkali metal hydroxide and aqueously dissolved alkali metal cyanide, and a solid phase with alkali metal cyanide crystals. By comparison with the second suspension, the proportion by weight of alkali metal cyanide crystals of the third suspension is lower.

The solid-liquid separation unit 18 has an inlet 19, a first outlet 20 and a second outlet 21. The alkali admixing unit removal conduit 17 is fluidically connected to the inlet 19. The alkali admixing unit removal conduit 17 thus fluidically interconnects the alkali admixing unit 12 and the solid-liquid separation unit 18. Second suspension can be introduced into the solid-liquid separation unit 18 through the alkali admixing unit removal conduit 17.

A first separation unit removal conduit 22 is fluidically connected to the first outlet 20. Solid-state alkali metal cyanide product can be removed from the solid-liquid separation unit 18 through the first separation unit removal conduit 22.

A second separation unit removal conduit 23 is fluidically connected to the second outlet 21. Third suspension can be removed from the solid-liquid separation unit 18 through the second separation unit removal conduit 23.

The second separation unit removal conduit 23 is fluidically connected to a first inlet 24 of the crystallization vessel 3. In other words, the second separation unit removal conduit 23 fluidically interconnects the solid-liquid separation unit 18 and the crystallization vessel 3. Third suspension can be removed from the solid-liquid separation unit 18 through the second separation unit removal conduit 23 and introduced into the crystallization vessel 3. The first inlet 24 of the crystallization vessel 3 is provided at a point beneath the liquid level 6 of the first suspension present in the suspension collection space 5 of the crystallization vessel 3.

The second separation unit removal conduit 23 has a pressure drop limiting unit 25 through which third suspension can flow, and with which a difference in operating pressure between an interior of the solid-liquid separation unit 18 and the interior 4 of the crystallization vessel can be maintained while third suspension is flowing through the pressure drop limiting unit 25. Third suspension can therefore flow out of the solid-liquid separation unit 18 into the crystallization vessel 3 in a pressure-neutral manner in respect of the operating pressure in the crystallization vessel 3.

The pressure drop limiting unit 25 may preferably have a liquid seal. In order to achieve the liquid seal function, for example, a U-shaped conduit section can be provided that works by the principle of a siphon. Such a liquid seal could also be referred to as a siphon-type liquid seal. This type of pressure drop limiting unit 25 may also take the form of what is called a feed well.

The suspension production unit 2 has a reaction loop 26 with which a fourth suspension can be produced, which contains a liquid phase with aqueously dissolved alkali metal hydroxide and aqueously dissolved alkali metal cyanide, and a solid phase with alkali metal cyanide crystals, wherein the fourth suspension has a lower proportion by weight of alkali metal hydroxide and a higher proportion by weight of alkali metal cyanide than the first suspension.

The reaction loop 26 has a hydrogen cyanide admixing unit 27 with which a liquid hydrogen cyanide-containing reactant liquid can be mixed into the first suspension. The hydrogen cyanide admixing unit 27 has a first inlet 28, a second inlet 29 and an outlet 30. A reaction feed conduit 31 is fluidically connected to the first inlet 28. In the present embodiment of the invention, the reaction feed conduit 31 is also fluidically connected to the suspension withdrawal conduit 10. It thus fluidically connects the suspension withdrawal conduit 10 to the hydrogen cyanide admixing unit 27. First suspension can be led from the suspension withdrawal conduit 10 into the hydrogen cyanide admixing unit 27 through the reaction feed conduit 31. The reaction feed conduit 31 has a second pump 32.

A hydrogen cyanide feed conduit 33 is fluidically connected to the second inlet 29. The liquid hydrogen cyanide-containing reactant liquid can be introduced into the hydrogen cyanide admixing unit through the hydrogen cyanide feed conduit 33.

A reaction removal conduit 34 is fluidically connected to the outlet 30 of the hydrogen cyanide admixing unit 27. Fourth suspension can be removed from the hydrogen cyanide admixing unit 27 via the reaction removal conduit 34.

The reaction removal conduit 34 is also fluidically connected to a second inlet 35 of the crystallization vessel 3. It thus fluidically interconnects the hydrogen cyanide admixing unit 27 and the crystallization vessel 3. Fourth suspension can be led into the crystallization vessel 3 through the reaction removal conduit 34.

The second inlet 35 of the crystallization vessel 3 is provided at a point beneath the liquid level 6 of the first suspension present in the suspension collection space 5 of the crystallization vessel 3.

The reaction removal conduit 34 has a heat exchanger 36 with which heat can be supplied to the fourth suspension.

The plant 1 has a second alkali feed conduit 37, which is fluidically connected to a third inlet 38 of the crystallization vessel 3. Using the third inlet 38, a reactant liquid containing aqueously dissolved alkali metal hydroxide can be introduced into the crystallization vessel 3 through the alkali feed conduit 37. The third inlet 38 is provided at a point above the liquid level 6 of the first suspension present in the suspension collection space 5 of the crystallization vessel 3. With the aid of a distribution unit (not shown in FIG. 1), the reactant liquid, distributed over a circumferential region of the crystallization vessel 3, is led onto an inner face 39 of a wall 40 of the crystallization vessel 3, and then runs down the inner face 39. Where the reactant liquid runs down the inner face 39, it counteracts alkali metal cyanide deposits on the inner face 39.

In the present embodiment of the invention, the first alkali feed conduit 16 is fluidically connected to the second alkali feed conduit 37 and is fed by the second alkali feed conduit 37 with the reactant liquid containing aqueously dissolved alkali metal hydroxide.

Above the distribution unit, in the interior 4 of the crystallization vessel 3, is provided a gas scrubbing module 41. The space between suspension collection space 5 and gas scrubbing module 41 is a first gas space 42, and the space above the gas scrubbing module 41 is a second gas space 43.

By means of the gas scrubbing module 41, hydrogen cyanide present in vapors ascending upward through the first gas space 42 can be scrubbed out. In this way, gas scrubbing can take place.

For feeding of the gas scrubbing module 41 with a gas scrubbing liquid containing aqueously dissolved alkali metal hydroxide, the crystallization vessel 3 has a fourth inlet 44 provided at a level of an upper region 45 of the gas scrubbing module 41, and, for removing gas scrubbing liquid from the gas scrubbing module 41, a second outlet 46 provided at a level of a lower region 47 of the gas scrubbing module 41. Fluidically connected to the fourth inlet 44 is a scrubbing module feed conduit 48 for supplying gas scrubbing liquid, and fluidically connected to the second outlet 46 is a scrubbing module removal conduit 49 for removing gas scrubbing liquid.

The gas scrubbing liquid removed remains separated from the suspensions and the solid-state product. It thus does not flow either into one of the first to fourth suspensions or into the solid-state product.

In the region of an upper end 50 of the crystallization vessel 3, a third outlet 51 is provided, to which a vapor withdrawal conduit 52 is fluidically connected. Vapors that have passed through the gas scrubbing module 41 can be removed from the second gas space 43 of the crystallization vessel 3 through the vapor withdrawal conduit 52.

The plant 1 has a vacuum unit 53 with an inlet 54, a first outlet 55 and a second outlet 56. The vapor withdrawal conduit 52 fluidically connects the second gas space 43 of the crystallization vessel 3 to the inlet 54 of the vacuum unit 53. By means of the vacuum unit 53, vapors can be sucked in and the subatmospheric pressure desired for operation of the crystallization vessel 3 can be generated.

Condensate formed in the vacuum unit 53 can be removed from the vacuum unit 53 through a first vacuum unit removal conduit 57 fluidically connected to the first outlet 55 of the vacuum unit 53.

The remaining stream of matter can be removed from the vacuum unit 53 through a second vacuum unit removal conduit 58 fluidically connected to the second outlet 56 of the vacuum unit 53.

In the production process conducted with the plant 1, first suspension is withdrawn from the suspension withdrawal conduit 10 and led into the reaction loop 26. In the present embodiment of the production process, a liquid hydrogen cyanide-containing reactant liquid is mixed into the first suspension in the hydrogen cyanide admixing unit 27. Alkali metal hydroxide in the liquid phase of the first suspension and hydrogen cyanide in the reactant liquid are converted to alkali metal cyanide and water. Accordingly, the fourth suspension has a smaller proportion by weight of alkali metal hydroxide and a higher proportion by weight of alkali metal cyanide compared to the first suspension.

Alkali metal cyanide crystals are newly formed, and alkali metal cyanide crystals already present grow, when the saturation limit for alkali metal cyanide has been attained in the liquid phase and further alkali metal cyanide is formed in the liquid phase and/or water is removed from the liquid phase, for example via evaporation. Both take place in the present embodiment of the production process. Alkali metal cyanide is formed in the liquid phase in the reaction loop 26, and water is evaporated in the crystallization vessel 3. In order to be able to evaporate the water at low temperatures, the crystallization vessel 3 is operated under subatmospheric pressure. The heat required for the evaporation of water comes partly from the exothermic conversion of alkali metal hydroxide and hydrogen cyanide to alkali metal cyanide and water. A further portion of heat is introduced in that the fourth suspension is heated further with the aid of the heat exchanger 36.

The heat exchanger 36 thus functions as a reboiler. For example, the heat exchanger 36 can heat the fourth suspension to a temperature of about 65° C.

As water is evaporated, alkali metal cyanide may break down, releasing hydrogen cyanide. In other words, hydrogen cyanide-containing vapors can form in the crystallization vessel 3.

The vapors flow through the gas scrubbing unit 41, in which hydrogen cyanide is scrubbed out of the vapors. The now cleaned vapors flow into the second gas space 43 and leave the crystallization vessel 3 through the outlet 51 and are removed through the vapor withdrawal conduit 52. The delivery action of the vacuum unit 53—it sucks the vapors out of the second gas space 43 through the vapor withdrawal conduit 52—maintains the desired operating subatmospheric pressure in the crystallization vessel 3.

In the alkali admixing unit 12, i.e. downstream of the connection site of the reaction loop 26, reactant liquid containing aqueously dissolved alkali metal hydroxide, in which the proportion by weight of alkali metal hydroxide is higher than that of the liquid phase of the first suspension, is mixed into the portion of the first suspension that flows further through the suspension withdrawal conduit 10 past the connection site of the reaction loop 26. As a result, the second suspension is produced, the liquid phase of which has a higher proportion by weight of alkali metal hydroxide than the liquid phase of the first suspension.

The reactant liquid containing aqueously dissolved alkali metal hydroxide is fed to the alkali admixing unit 12 through the first alkali feed conduit 16.

The second suspension is removed from the alkali admixing unit 12 and introduced into the solid-liquid separation unit 18 through the alkali admixing unit removal conduit 17. In the solid-liquid separation unit 18, in the course of the separating off solid phase of the second suspension, the second suspension is separated into a solid-state alkali metal cyanide product and a third suspension. The third suspension has a lower proportion by weight of alkali metal cyanide crystals compared to the second suspension.

The solid-state alkali metal cyanide product is removed from the solid-liquid separation unit 18 through the first separation unit removal conduit 22, and the third suspension through the second separation unit removal conduit 23.

The solid-liquid separation unit 18 is a type of solid-liquid separation unit that does not fully separate the liquid phase from the solid phase. It may take the form, for example, of a filter or centrifuge. Since the solid-liquid separation unit 18 does not fully separate the liquid phase from the solid phase, the solid-state alkali metal cyanide product also has a liquid phase. The level of the proportion by weight thereof depends in particular on the effectiveness with which liquid phase is separated from solid phase in the solid-liquid separation unit 18.

The solid-state alkali metal cyanide product may, for example, be a crystal slurry or a merely wet or moist crystal product. If an even drier solid-state alkali metal cyanide product is desired, the solid-state alkali metal cyanide product removed from the solid-liquid separation unit 18 may be sent to a further drying operation.

Because the liquid phase of the second suspension has a higher proportion by weight of alkali metal hydroxide than that of the first suspension, the solid-state alkali metal cyanide product has a higher proportion by weight of alkali metal hydroxide than if first suspension had been introduced into the solid-liquid separation unit 18 rather than the second suspension.

The third suspension is led into the crystallization vessel 3 through the second separation unit removal conduit 23. Since the liquid phase of the third suspension has a higher proportion by weight of alkali metal hydroxide than that of the first suspension, a further portion of the alkali metal hydroxide consumed in the formation of alkali metal cyanide in the reaction loop 26 is replaced by Introducing the third suspension into the crystallization vessel 3.

There is a higher absolute operating pressure in the solid-liquid separation unit 18 than in the crystallization vessel 3. The crystallization vessel 3 is operated under subatmospheric pressure, which lowers the boiling temperature of water in the crystallization vessel 3. The pressure drop limiting unit 25 of the second separation unit removal conduit 23 ensures that flow of third suspension from the solid-liquid separation unit 18 into the crystallization vessel 3 occurs in a pressure-neutral manner in respect of the operating pressure in the crystallization vessel 3.

The alkali metal hydroxide used may, for example, be sodium hydroxide, in which case the resultant solid-state alkali metal cyanide product would be a solid-state sodium cyanide product, or potassium hydroxide, in which case the resultant solid-state alkali metal cyanide product would be a solid-state potassium cyanide product.

1. A plant for producing a solid-state alkali metal cyanide product containing alkali metal hydroxide, wherein the plant comprises:
(i) a suspension production unit for producing a first suspension that contains a liquid phase with aqueously dissolved alkali metal cyanide and aqueously dissolved alkali metal hydroxide, and a solid phase with alkali metal cyanide crystals, wherein the suspension production unit has a crystallization vessel in which a suspension collection space for collecting first suspension is provided;
(ii) a suspension withdrawal conduit for removing first suspension from the suspension collection space of the crystallization vessel;
(iii) an alkali admixing unit for producing a second suspension containing a liquid phase with aqueously dissolved alkali metal cyanide and aqueously dissolved alkali metal hydroxide, and a solid phase with alkali metal cyanide crystals, by mixing into the first suspension a reactant liquid containing aqueously dissolved alkali metal hydroxide, wherein the proportion by weight of alkali metal hydroxide of the reactant liquid is higher than the proportion by weight of alkali metal hydroxide of the liquid phase of the first suspension,
wherein the suspension withdrawal conduit fluidically interconnects the suspension collection space of the crystallization vessel of the suspension production unit and the alkali admixing unit, and first suspension can be led from the suspension collection space into the alkali admixing unit through the suspension withdrawal conduit;
(iv) an alkali admixing unit removal conduit for removing second suspension from the alkali admixing unit;
(v) a solid-liquid separation unit with which the second suspension can be separated by separating solid-phase of the second suspension into a solid-state alkali metal cyanide product and a third suspension containing a liquid phase with aqueously dissolved alkali metal cyanide and aqueously dissolved alkali metal hydroxide, and a solid phase with alkali metal cyanide crystals,
wherein the alkali admixing unit removal conduit fluidically interconnects the alkali admixing unit and the solid-liquid separation unit, and second suspension can be led from the alkali admixing unit into the solid-liquid separation unit through the alkali admixing unit removal conduit;
(vi) a first separation unit removal conduit for removing solid-state alkali metal cyanide product from the solid-liquid separation unit;
(vii) a second separation unit removal conduit for removing third suspension from the solid-liquid separation unit.

2.-14. (canceled)

15. The plant as claimed in claim 1, wherein water in the liquid phase of the first suspension is evaporated in the crystallization vessel.

16. The plant as claimed in claim 1, wherein the second separation unit removal conduit fluidically interconnects the solid-liquid separation unit and the crystallization vessel of the suspension production unit, and third suspension can be removed from the solid-liquid separation unit and led into the crystallization vessel through the second separation unit removal conduit.

17. The plant as claimed in claim 16, wherein the second separation unit removal conduit has a pressure drop limiting unit through which third suspension can flow and with which an operating pressure difference between the solid-liquid separation unit and the crystallization vessel of the suspension production unit can be maintained while third suspension is flowing through the pressure drop limiting unit.

18. The plant as claimed in claim 1, comprising:
a reaction loop for producing a fourth suspension, containing a liquid phase with aqueously dissolved alkali metal cyanide and aqueously dissolved alkali metal hydroxide, and a solid phase with alkali metal cyanide crystals, wherein
first suspension can be introduced into the reaction loop,
the reaction loop has a hydrogen cyanide admixing unit with which, by mixing a liquid hydrogen cyanide-containing reactant liquid into the first suspension, the fourth suspension having a lower proportion by weight of aqueously dissolved alkali metal hydroxide and a higher proportion by weight of alkali metal cyanide by comparison with the first suspension can be produced, and
fourth suspension can be introduced into the crystallization vessel.

19. The plant as claimed in claim 18, wherein
the reaction loop is fluidically connected to the suspension withdrawal conduit, wherein first suspension can be removed from the suspension withdrawal conduit and led into the reaction loop, and
the reaction loop is fluidically connected to the crystallization vessel, and fourth suspension can be led from the reaction loop into the crystallization vessel.

20. The plant as claimed in claim 1, comprising:
an alkali feed conduit, which is fluidically connected to the crystallization vessel and through which a reactant liquid containing aqueously dissolved alkali metal hydroxide can be led into the crystallization vessel.

21. The plant as claimed in claim 20, wherein the alkali admixing unit is fluidically connected to the alkali feed conduit, and reactant liquid containing aqueously dissolved alkali metal hydroxide can be led from the alkali feed conduit into the alkali admixing unit.

22. A process for producing a solid-state alkali metal cyanide product containing alkali metal hydroxide, the process comprising:
(a) producing a first suspension containing a liquid phase with aqueously dissolved alkali metal cyanide and aqueously dissolved alkali metal hydroxide, and a solid phase with alkali metal cyanide crystals, in a suspension production unit, wherein the suspension production unit has a crystallization vessel;
(b) removing first suspension from the crystallization vessel of the suspension production unit;
(c) producing a second suspension containing a liquid phase with aqueously dissolved alkali metal cyanide and aqueously dissolved alkali metal hydroxide, and a solid phase with alkali metal cyanide crystals, by mixing first suspension removed from the crystallization vessel with a reactant liquid containing aqueously dissolved alkali metal hydroxide,
wherein the proportion by weight of alkali metal hydroxide in the reactant liquid is higher than the proportion by weight of alkali metal hydroxide in the liquid phase of the first suspension;
(d) introducing the second suspension into a solid-liquid separation unit and separating the second suspension into a solid-state alkali metal cyanide product and a third suspension containing a liquid phase with aqueously dissolved alkali metal cyanide and aqueously dissolved alkali metal hydroxide, and a solid phase with alkali metal cyanide crystals;
(e) removing solid-state alkali metal cyanide product from the solid-liquid separation unit;
(f) removing third suspension from the solid-liquid separation unit.

23. The process as claimed in claim 22, comprising:
leading third suspension from the solid-liquid separation unit into the crystallization vessel of the suspension production unit.

24. The process as claimed in claim 23, comprising:
maintaining an operating pressure difference between the solid-liquid separation unit and the crystallization vessel while third suspension is led from the solid-liquid separation unit into the crystallization vessel.

25. The process as claimed in claim 22, comprising:
leading first suspension into a reaction loop,
producing, in the reaction loop, a fourth suspension by mixing a liquid hydrogen cyanide-containing reactant liquid into the first suspension and wherein the fourth suspension contains a liquid phase with aqueously dissolved alkali metal cyanide and aqueously dissolved alkali metal hydroxide, and a solid phase with alkali metal cyanide crystals, wherein the fourth suspension has a lower proportion by weight of aqueously dissolved alkali metal hydroxide and a higher proportion by weight of alkali metal cyanide compared to the first suspension, and
leading the fourth suspension into the crystallization vessel.

26. The process as claimed in claim 22, comprising:
leading a reactant liquid containing aqueously dissolved alkali metal hydroxide into the crystallization vessel through an alkali feed conduit.

27. The process as claimed in claim 26, comprising:
removing reactant liquid containing aqueously dissolved alkali metal hydroxide from the alkali feed conduit, and
mixing, in (c), said removed reactant liquid containing aqueously dissolved alkali metal hydroxide into the first suspension.

28. The plant as claimed in claim 17, comprising:
an alkali feed conduit, which is fluidically connected to the crystallization vessel and through which a reactant liquid containing aqueously dissolved alkali metal hydroxide can be led into the crystallization vessel.

29. The plant as claimed in claim 28, wherein the alkali admixing unit is fluidically connected to the alkali feed conduit, and reactant liquid containing aqueously dissolved alkali metal hydroxide can be led from the alkali feed conduit into the alkali admixing unit.

30. The process as claimed in claim 24, comprising:
leading a reactant liquid containing aqueously dissolved alkali metal hydroxide into the crystallization vessel through an alkali feed conduit.

31. The process as claimed in claim 30, comprising:
removing reactant liquid containing aqueously dissolved alkali metal hydroxide from the alkali feed conduit, and
mixing, in (c), said removed reactant liquid containing aqueously dissolved alkali metal hydroxide into the first suspension.

32. The plant as claimed in claim 16, comprising:
an alkali feed conduit, which is fluidically connected to the crystallization vessel and through which a reactant liquid containing aqueously dissolved alkali metal hydroxide can be led into the crystallization vessel.

33. The plant as claimed in claim 32, wherein the alkali admixing unit is fluidically connected to the alkali feed conduit, and reactant liquid containing aqueously dissolved alkali metal hydroxide can be led from the alkali feed conduit into the alkali admixing unit.

34. The process as claimed in claim 23, comprising:
leading a reactant liquid containing aqueously dissolved alkali metal hydroxide into the crystallization vessel through an alkali feed conduit.

35. The process as claimed in claim 34, comprising:
removing reactant liquid containing aqueously dissolved alkali metal hydroxide from the alkali feed conduit, and
mixing, in (c), said removed reactant liquid containing aqueously dissolved alkali metal hydroxide into the first suspension.
